(19) United States
(12) Patent Application Publication
(10) Pub. No.: US 2010/0027266 A1
(43) Pub. Date: Feb. 4, 2010

(54) Illuminating Device

(75) Inventors: Yu-Hsin Tsai, Sinjhuang City (TW); Meng-Hsieh Chou, Sinjhuang City (TW); You-Chuen Lian, Sinjhuang City (TW)

Correspondence Address: Stevens Law Group, 1754 Technology Drive, Suite #226, San Jose, CA, 95110, US

(73) Assignee: I-Chiun Precision Industry Co., Ltd

(21) Appl. No.: 12/182,982

(22) Filed: Jul. 30, 2008

(51) Int. Cl. F21V 29/00

(52) U.S. Cl. 362/267; 362/294

(57) ABSTRACT

An illuminating device using light-emitting diodes as its light source is provided. The light-emitting diode module is disposed on a heat-dissipating substrate with at least one heat-dissipating surface, so that the heat generated by the working light-emitting diodes can be rapidly removed. In this case, the illuminating device simultaneously has the advantages of high luminosity, low power consumption, good light-emitting efficiency, and long lifetime.

### BACKGROUND OF THE INVENTION

1. Field of Invention

The invention relates to an illuminating device and, in particular, to a light-emitting diode illuminating device that can be installed on a machining platform.

2. Related Art

Generally speaking, an illuminating device is usually provided at blade machining position of a machining platform. Such an illuminating device usually uses lamps or light bulbs as its light source. However, these conventional lamps or light bulbs have the drawbacks of high temperature and power consumption. Moreover, disposals of fluorescent lamps, neon lights, and quartz light bulbs will result in environmental problems. Therefore, the light-emitting diodes (LED's) have been developed in recent years to be the light source of the working lamp.

Although the LED has the advantages of low power consumption, long device lifetime, zero warm-up time, and quick responses, the luminosity of a normal LED is worse than a conventional light bulb or lamp. Therefore, high-power LED's are used as the illuminating light source. Although such a high-power LED can provide a better luminosity, its temperature rises after continuously emitting light for some time. This affects its light-emitting efficiency. It is thus seen that a good heat-dissipating mechanism is necessary for a high-power LED to be the light source of an illuminating device.

Consequently, it is a focus topic for researchers to develop an LED illuminating device with high luminosity and good heat dissipation.

### SUMMARY OF THE INVENTION

In view of the foregoing, the invention discloses an illuminating device that uses LED's as its light source. The LED's are disposed on a substrate with good heat dissipation. Therefore, in addition to provide high-luminosity light, the invention has a longer lifetime due to its good heat-dissipating property.

The disclosed illuminating device includes a heat-dissipating substrate, a first separator, at least one LED light source module, a power module, an optical film, a transparent board, two protection covers, and a waterproof stripe. The heat-dissipating substrate has an accommodating tank, a top surface, and at least one heat-dissipating surface. The heat-dissipating surface is outside the accommodating tank. The top surface has an opening that exposes the accommodating tank. The first separator is inserted in the accommodating tank to separate a first accommodating space and a second accommodating space. The first separator has a connecting hole. The LED light source module is disposed in the second accommodating space and in touch with the heat-dissipating substrate. The power module is disposed in the first accommodating space and is electrically connected with the LED light source module via the connecting hole on the first separator.

In this embodiment, the transparent board is fixed on the top surface of the heat-dissipating substrate. The protection covers are fixed on both ends of the heat-dissipating substrate. Along with the transparent board, the protection covers seal the power module and the LED light source module in the first accommodating space and the second accommodating space, respectively. At least one of the protection covers has a through hole. The power module is electrically connected with an external power supply via the through hole.

The invention provides an illuminating device comprising a heat-dissipating substrate, a first separator, at least one LED light source module, a power module, an optical film, a transparent board, two protection covers, and a waterproof stripe. The heat-dissipating substrate has an accommodating tank, a top surface, and at least one heat-dissipating surface. The heat-dissipating surface is outside the accommodating tank. The top surface has an opening that exposes the accommodating tank. The first separator is inserted in the accommodating tank to separate a first accommodating space and a second accommodating space. The first separator has a connecting hole. The LED light source module is disposed in the second accommodating space and in touch with the heat-dissipating substrate. The power module is disposed in the first accommodating space and is electrically connected with the LED light source module via the connecting hole on the first separator.

In this embodiment, the optical film is disposed above the LED light source module. The transparent board is fixed on the top surface of the heat-dissipating substrate. The protection covers are fixed on both ends of the heat-dissipating substrate. Along with the transparent board, the protection covers seal the power module and the LED light source module in the first accommodating space and the second accommodating space, respectively. At least one of the protection covers has a through hole. The power module is electrically connected with an external power supply via the through hole.

The invention provides an illuminating device comprising a heat-dissipating substrate, a first separator, at least one LED light source module, a power module, an optical film, a transparent board, two protection covers, and a waterproof stripe. The heat-dissipating substrate has an accommodating tank, a top surface, and at least one heat-dissipating surface. The heat-dissipating surface is outside the accommodating tank. The top surface has a first groove extended along the accommodating tank and an opening that exposes the accommodating tank. The first separator is inserted in the accommodating tank to separate a first accommodating space and a second accommodating space. The first separator has a connecting hole. The LED light source module is disposed in the second accommodating space and in touch with the heat-dissipating substrate. The power module is disposed in the first accommodating space and is electrically connected with the LED light source module via the connecting hole on the first separator.

In this embodiment, the optical film is disposed above the LED light source module. The transparent board is fixed on the top surface of the heat-dissipating substrate. The protection covers are fixed on both sides of the heat-dissipating substrate. Along with the transparent board, the protection covers seal the power module and the LED light source module in the first accommodating space and the second accommodating space, respectively. The contact surface between each of the protection covers and the heat-dissipating substrate has a second groove surrounding one end of the accommodating tank. At least one of the protection covers has a through hole. The power module is electrically connected with an external power supply via the through hole. The waterproof stripe has a body part and two extension parts. The extension parts are connected to both ends of the body part, respectively. The body part is embedded in a first embedding slot of the heat-dissipating substrate. The extension parts are embedded in second embedding slots of the protection covers.

The difference between the invention and the prior art is in that the invention utilizes LED's as its light source and uses a heat-dissipating substrate with at least one heat-dissipating surface to support the LED light source module. The heat produced by the working LED chip can thus be quickly removed. Using this technique, the disclosed illuminating device can simultaneously have the advantages of high luminosity, lower power consumption, good light-emitting efficiency, and long lifetime.

### BRIEF DESCRIPTION OF THE DRAWINGS

The invention will become more fully understood from the detailed description given herein below illustration only, and thus is not limitative of the present invention, and wherein:

FIG. 1 is a three-dimensional exploded view of the illuminating device according to the first embodiment of the invention.

FIG. 2 is a side view of the heat-dissipating substrate in the disclosed illuminating device.

FIG. 3 is a three-dimensional view showing the separator in the heat-dissipating substrate of the first embodiment.

FIG. 4 is a cross-sectional view of a part of the disclosed illuminating device.

FIG. 5 is a three-dimensional exploded view of the illuminating device according to the second embodiment of the invention.

FIG. 6 is a three-dimensional view showing the separator in the heat-dissipating substrate of the second embodiment.

FIG. 7 is a three-dimensional view of the protection covers and the heat-dissipating substrate in the third embodiment of the invention.

### DETAILED DESCRIPTION OF THE INVENTION

The present invention will be apparent from the following detailed description, which proceeds with reference to the accompanying drawings, wherein the same references relate to the same elements.

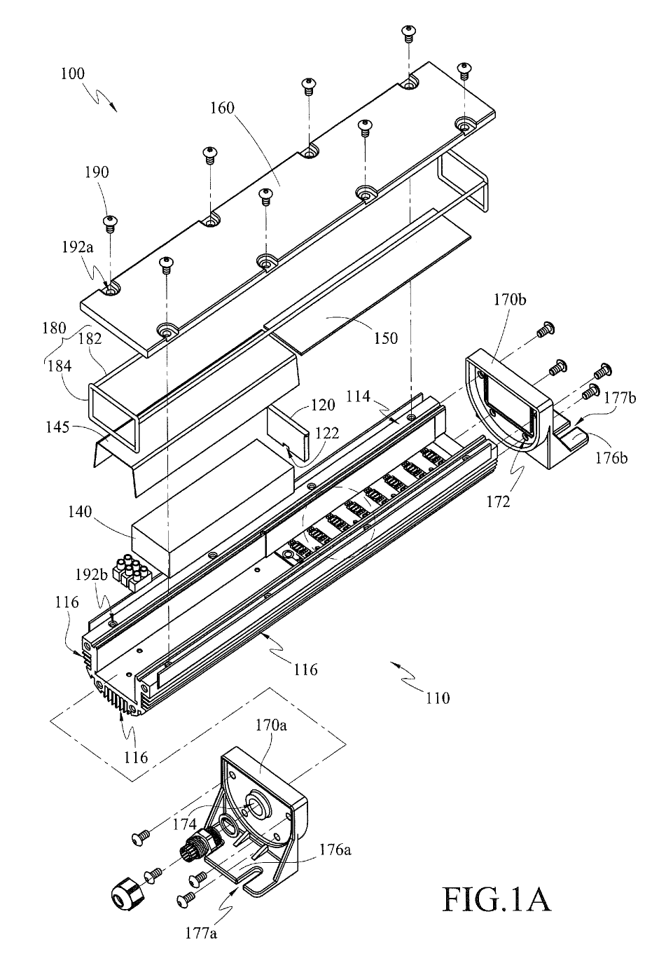

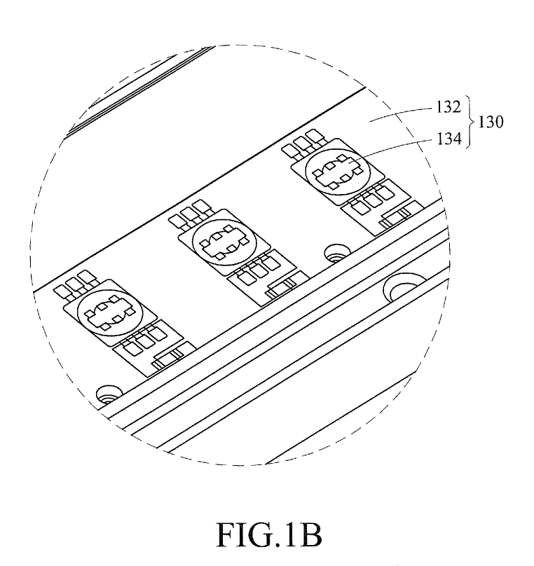

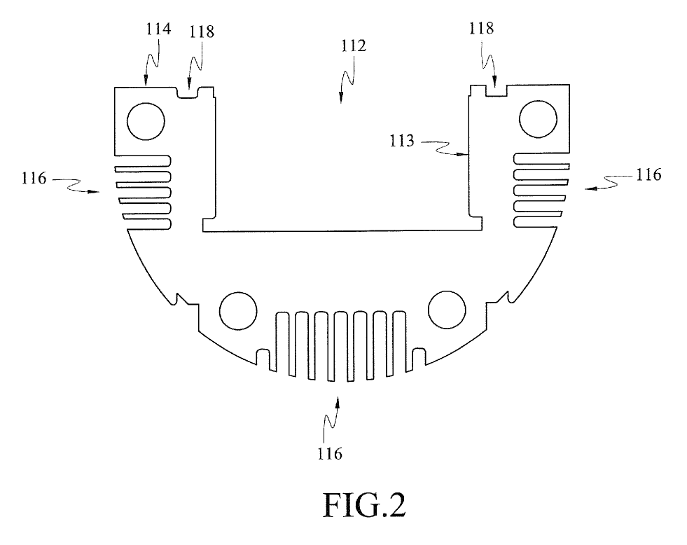

FIG. 1 is a three-dimensional exploded view of the disclosed illuminating device, and FIG. 2 is a side view of the heat-dissipating substrate thereof. With simultaneous reference to FIGS. 1 and 2, the illuminating device 100 includes a heat-dissipating substrate 110, a first separator 120, at least one LED light source module 130, a power module 140, a transparent board 160, a protection cover 170a and a protection cover 170b. The heat-dissipating substrate 110 is made by aluminum extrusion, and has an accommodating tank 112, a top surface 114, and at least one heat-dissipating surface 116. In this embodiment, the heat-dissipating substrate 110 has three heat-dissipating surfaces 116, all outside the accommodating tank 112. More explicitly, the heat-dissipating surfaces 116 can be the outer surfaces on both sides of the heat-dissipating substrate 110 and its bottom surface. The heat-dissipating surfaces 116 may have a fin shape to increase the heat-dissipating area of the heat-dissipating substrate 110.

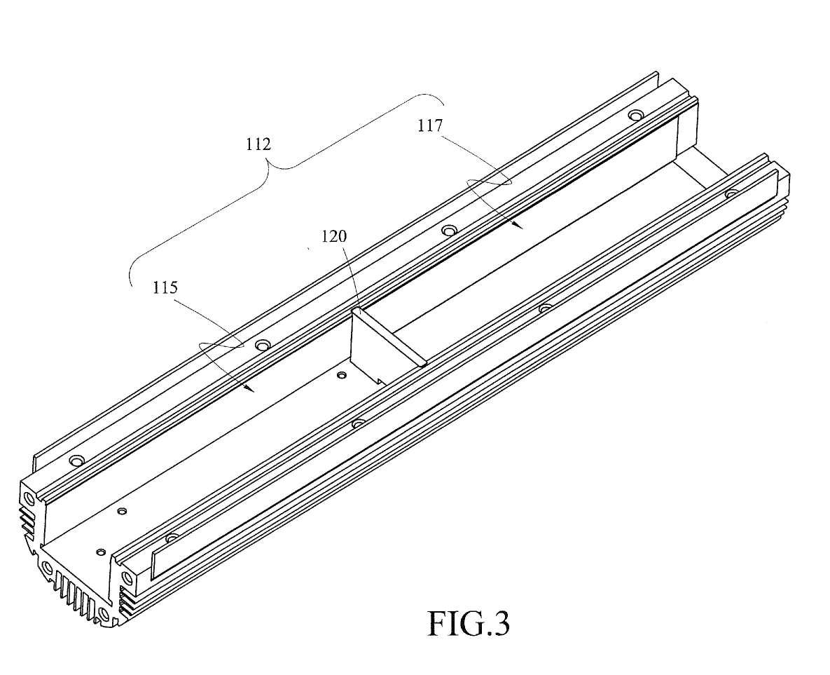

The top surface 114 of the heat-dissipating substrate 110 has an opening 113 for exposing the accommodating tank 112. As shown in FIG. 3, when assembling the illuminating device 100, one can insert the first separator 120 via the opening 113 of the top surface 114 into the accommodating tank 112, separating a first accommodating space 115 and a second accommodating space 117.

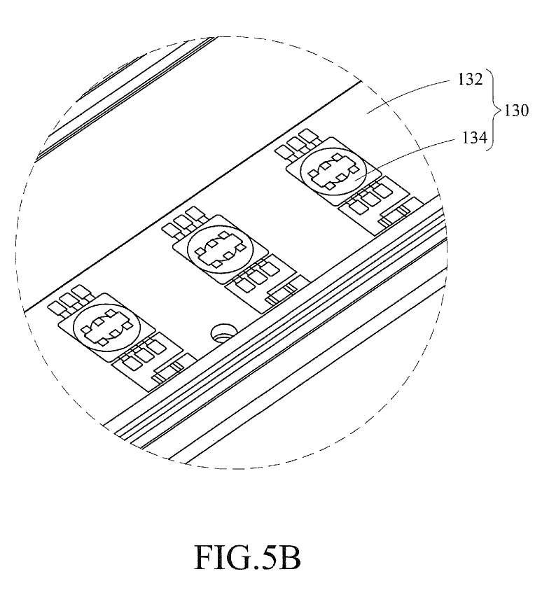

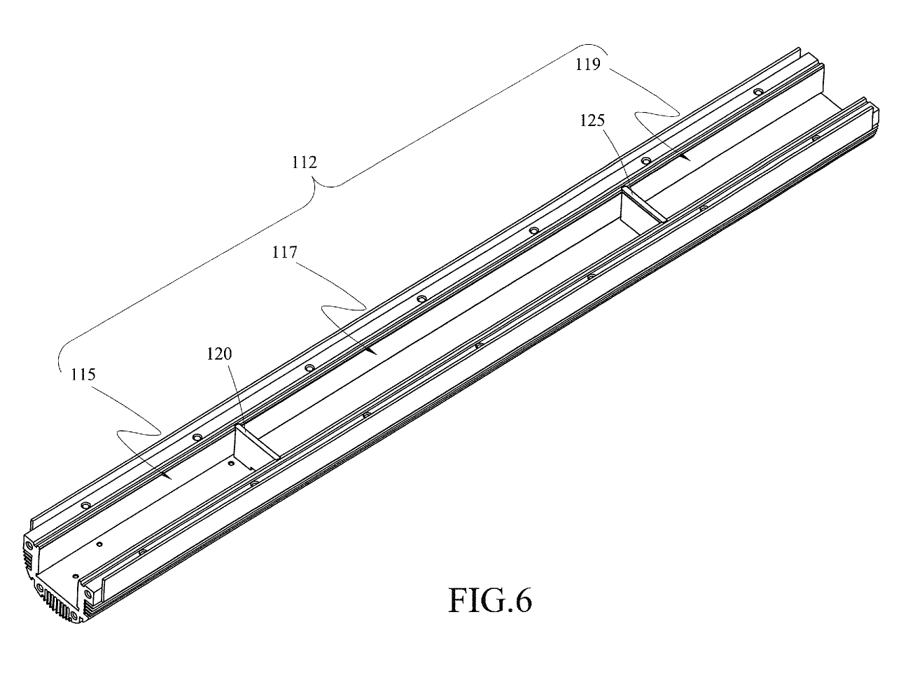

Besides, as shown in FIGS. 5 and 6, the second embodiment of the disclosed illuminating device further includes a second separator 125 inserted into the accommodating tank 112 roughly in parallel to the first separator, together forming a first accommodating space 115, a second accommodating space 117, and a third accommodating space 119. The second accommodating space 117 is between the first accommodating space 115 and the third accommodating space 119. It should be mentioned that the first accommodating space 115 and the third accommodating space 119 are geometrically symmetric to each other in this embodiment.

Please refer again to FIGS. 1 and 2. The LED light source module 130 is disposed in the second accommodating space 117 and in touch with the heat-dissipating substrate 110. The power module 140 is disposed in the first accommodating space 115, and is electrically connected with the LED light source module 130 via the connecting hole 122 of the first separator 120. The power module 140 is a transformer, for example.

It is noted that although FIG. 1 only depicts a single LED light source module 130, it should not be used to restrict the number of LED light source modules in the invention. Any person skilled in the art can decide the number of LED light source modules 130 disposed in the second accommodating space 117 according to the need. They are still covered by the invention.

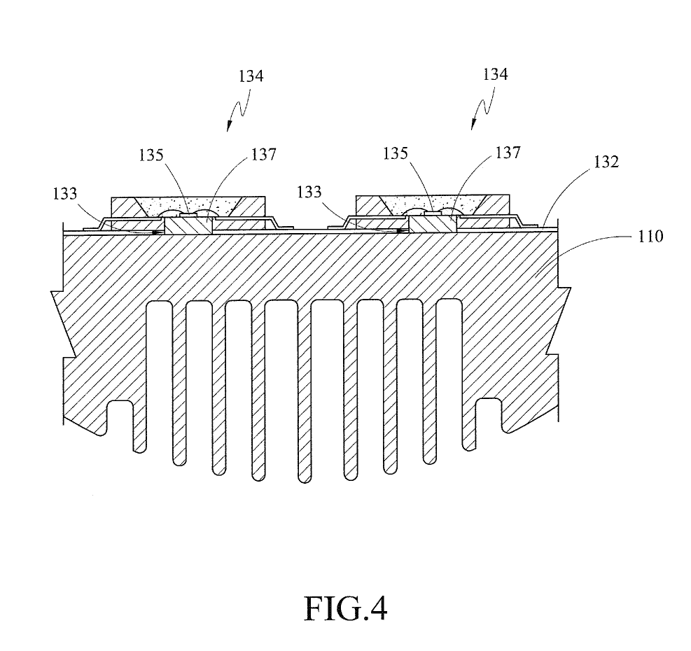

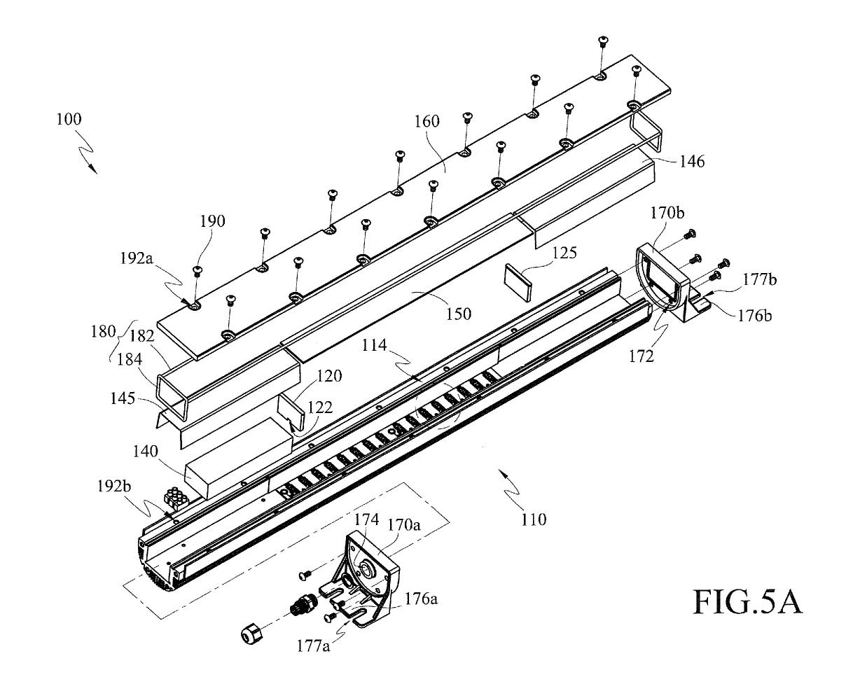

Following the above description, the LED light source module 130 includes a circuit board 132 and several LED packaging structures 134 disposed on the circuit board 132 in an array. As shown in FIG. 4, the circuit board 132 has several heat-dissipating holes 133. In each of the LED packaging structures 134, the LED chip 135 is disposed on a heat-dissipating block 137. The heat-dissipating block 137 of each LED packaging structure 134 goes through the heat-dissipating holes 133 of the circuit board 132. Therefore, the heat produced by working LED chip 135 can be directly transferred from the heat-dissipating block 137 to the circuit board 132 and then to the heat-dissipating substrate 110. The heat-dissipating surfaces 116 at the bottom of the heat-dissipating substrate 110 quickly dissipate the heat to avoid heat accumulation inside the illuminating device 100.

Please refer to FIG. 1. The illuminating device 100 in this embodiment further includes a cover board 145 disposed above the power module 140 and fixed in the first accommodating space 115. The cover board 145 can be an aluminum board bent into a U shape. Therefore, when it is disposed in the first accommodating space 115, the cover board 145 slightly extends toward both sides of the heat-dissipating substrate 110 and gets fixed in the first accommodating space 115.

On the other hand, as shown in FIG. 5, the illuminating device 200 in the second embodiment further has another cover board 146 in addition to the cover board 145. The cover board 146 is disposed between the transparent board 160 and the third accommodating space 119 and fixed in the third accommodating space 119. The material, shape, and properties of the cover board 146 are the same as or similar to those of the cover board 145, and therefore are not described here again.

As shown in FIG. 1, the transparent board 160 is fixed on the top surface 114 of the heat-dissipating substrate 110. The light emitted by the LED light source module 130 goes out of the transparent board 160 for illumination. It should be mentioned that the illuminating device 100 can further includes an optical film 150 disposed above the LED light source module 130. In this embodiment, the optical film 150 can prevent glares so that the invention results no overlapped images after the light from the LED light source module 130 goes out of the transparent board 160.

Besides, since the transparent board 160 in this embodiment is fixed on the top surface 114 of the heat-dissipating substrate 110 via a fixing element 190, the transparent board 160 and the top surface 114 of the heat-dissipating substrate 110 have the corresponding fixing holes 192a, 192b, respectively. The fixing element 190 goes through the fixing holes 192a and 192b in sequence, locking the transparent board 160 on the top surface 114 of the heat-dissipating substrate 110. In particular, the fixing element 190 can be a screw, rivet, or equivalent.

Both ends of the heat-dissipating substrate 110 are fixed with the protection covers 170a, 170b to seal the power module 140 and the LED light source module 130 in the first accommodating space 115 and the second accommodating space 117, respectively. The protection covers 170a, 170b in this embodiment are connected by embedding to both ends of the heat-dissipating substrate 110 using screw, rivets, or equivalents.

In addition, the protection cover 170a near the first accommodating space 115 has a through hole 174. The power module 140 disposed in the first accommodating space 115 is electrically connected with an external power supply (not shown) via the through hole 174. The protection covers 170a, 170b have vertical extension parts 176a, 176b, respectively. The vertical extension part 176a has a positioning groove 177a, and the vertical extension part 176b has a positioning groove 177b. The illuminating device 100 is installed and positioned on a machining platform (not shown) using the positioning grooves 177a, 177b for illumination.

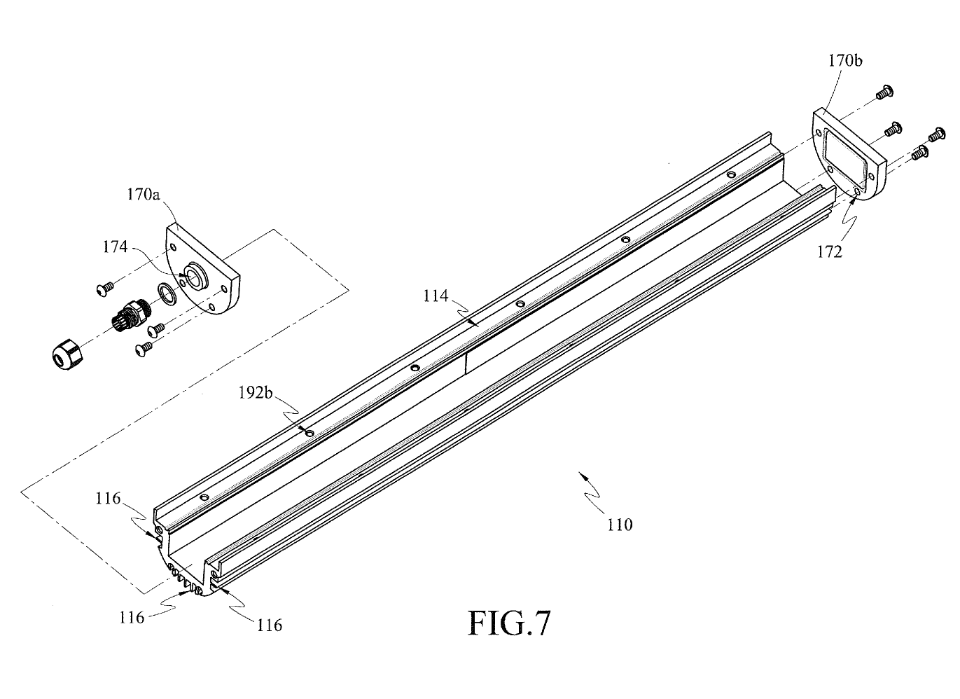

However, the invention does not specify the connection method between the protection covers 170a, 170b and the heat-dissipating substrate 110. In the third embodiment of the invention, as shown in FIG. 7, the protection covers 170a, 170b can be flat plates. They are directly locked on the heat-dissipating substrate 110 using screws, rivets, or other equivalents. Besides, the illuminating device with the protection covers 170a, 170b in FIG. 7 can be installed on a machining platform using another snapping tool.

Please refer again to FIG. 1. More particularly, the illuminating device 100 in this embodiment further includes a waterproof stripe 180 to prevent moisture from entering the accommodating tank 112. This can prevent the LED light source module 130 form being damaged due to moisture. Explicitly speaking, the top surface 114 of the heat-dissipating substrate 110 has a first embedding groove extended along the accommodating tank 112. The contact surfaces between the protection covers 170a, 170b and the heat-dissipating substrate 110 have a second embedding groove 172 surrounding one end of the accommodating tank 112, respectively. The waterproof stripe is embedded in the first embedding groove 118 and the second embedding grooves 172.

In more detail, the waterproof stripe 180 has a body part 182 and two extension parts 184 connected to both ends of the body part 182, respectively. The body part 182 is embedded in the first embedding groove 118 on the top surface 114 of the heat-dissipating substrate 110. The extension parts 184 on both ends of the body part 182 are embedded in the second embedding grooves 172 of the protection covers 170a, 170b, respectively. Consequently, the disclosed illuminating device 100 uses the waterproof stripe to effectively prevent moisture from entering and damaging the LED light source module 130 therein.

In summary, the disclosed illuminating device uses LED's as its light sources. It utilizes a heat-dissipating substrate with at least one heat-dissipating surface to support the LED light source module. The heat produced by the working LED chips can be rapidly removed. Therefore, the disclosed illuminating device has simultaneously the advantages of high luminosity, low power consumption, good light-emitting efficiency, and long lifetime.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An illuminating device, comprising:
a heat-dissipating substrate, which has an accommodating tank, a top surface, and at least one heat-dissipating surface outside the accommodating tank, the top surface having an opening to expose the accommodating tank;
a first separator having a connecting hole, which is inserted in the accommodating tank to separate a first accommodating space and a second accommodating space;
at least one light-emitting diode (LED) light source module, which is disposed in the second accommodating space and in touch with the heat-dissipating substrate;
a power module, which is disposed in the first accommodating space and electrically connected with the LED light source module through the connecting hole;
a transparent board, which is fixed on the top surface of the heat-dissipating substrate; and
two protection covers, which are fixed respectively on both ends of the heat-dissipating substrate to, along with the transparent board, seal the power module and the LED light source module in the first accommodating space and the second accommodating space, respectively, wherein at least one of the protection covers has a through hole and the power module is electrically connected with an external power supply via the through hole.

2. The illuminating device of claim 1, wherein the heat-dissipating substrate has a plurality of heat-dissipating surfaces that are side and bottom surfaces thereof.

3. The illuminating device of claim 2, wherein the heat-dissipating surfaces have a fin shape.

4. The illuminating device of claim 1, wherein the LED light source module includes:
a circuit board, which has a plurality of heat-dissipating holes; and
a plurality of LED packaging structures disposed on the circuit board, each of which includes at least an LED chip and a heat-dissipating block;
wherein each of the LED chips is disposed on a corresponding heat-dissipating block, and each of the heat-dissipating blocks goes through one of the heat-dissipating holes to touch the heat-dissipating substrate.

5. The illuminating device of claim 1 further comprising a cover board disposed above the power module and fixed in the first accommodating space.

6. The illuminating device of claim 5, wherein the cover board has a U shape.

7. The illuminating device of claim 1 further comprising a second separator inserted inside the accommodating tank roughly in parallel to the first separator to separate the first accommodating space, the second accommodating space, and a third accommodating space in the accommodating tank, wherein the second accommodating space is between the first accommodating space and the third accommodating space.

8. The illuminating device of claim 7 further comprising a cover board disposed between the transparent board and the third accommodating space and fixed in the third accommodating space.

9. The illuminating device of claim 8, wherein the cover board has a U shape.

10. The illuminating device of claim 1, wherein each of the protection covers has a vertical extension part with at least one positioning groove.

11. An illuminating device, comprising:
a heat-dissipating substrate, which has an accommodating tank, a top surface, and at least one heat-dissipating surface outside the accommodating tank, the top surface having an opening to expose the accommodating tank;
a first separator having a connecting hole, which is inserted in the accommodating tank to separate a first accommodating space and a second accommodating space;
at least one LED light source module, which is disposed in the second accommodating space and in touch with the heat-dissipating substrate;
a power module, which is disposed in the first accommodating space and electrically connected with the LED light source module through the connecting hole;
an optical film, which is disposed above the LED light source module;
a transparent board, which is fixed on the top surface of the heat-dissipating substrate; and
two protection covers, which are fixed respectively on both ends of the heat-dissipating substrate to, along with the transparent board, seal the power module and the LED light source module in the first accommodating space and the second accommodating space, respectively, wherein at least one of the protection covers has a through hole and the power module is electrically connected with an external power supply via the through hole.

12. The illuminating device of claim 11, wherein the optical film is an anti-glare plate.

13. The illuminating device of claim 11, wherein the heat-dissipating substrate has a plurality of heat-dissipating surface that are side and bottom surfaces thereof.

14. The illuminating device of claim 11 further comprising a second separator inserted inside the accommodating tank roughly in parallel to the first separator to separate the first accommodating space, the second accommodating space, and a third accommodating space in the accommodating tank, wherein the second accommodating space is between the first accommodating space and the third accommodating space.

15. The illuminating device of claim 14 further comprising a cover board disposed between the transparent board and the third accommodating space and fixed in the third accommodating space.

16. The illuminating device of claim 11, wherein each of the protection covers has a vertical extension part with at least one positioning groove.

17. An illuminating device, comprising:
a heat-dissipating substrate, which has an accommodating tank, a top surface, and at least one heat-dissipating surface outside the accommodating tank, the top surface having a first embedding groove extended along the accommodating tank and an opening to expose the accommodating tank;
a first separator having a connecting hole, which is inserted in the accommodating tank to separate a first accommodating space and a second accommodating space;
at least one LED light source module, which is disposed in the second accommodating space and in touch with the heat-dissipating substrate;
a power module, which is disposed in the first accommodating space and electrically connected with the LED light source module through the connecting hole;
an optical film, which is disposed above the LED light source module;
a transparent board, which is fixed on the top surface of the heat-dissipating substrate;
two protection covers, which are fixed respectively on both ends of the heat-dissipating substrate to, along with the transparent board, seal the power module and the LED light source module in the first accommodating space and the second accommodating space, respectively; wherein the contact surface between each of the protection covers and the heat-dissipating substrate has a second embedding groove surrounding one end of the accommodating tank, and at least one of the protection covers has a through hole and the power module is electrically connected with an external power supply via the through hole; and
a waterproof stripe, which has a body part and two extension parts connected to both ends of the body part, respectively, wherein the body part is embedded in the first embedding groove of the heat-dissipating substrate and the extension parts are embedded in the second embedding grooves of the protection covers.

18. The illuminating device of claim 17, wherein the optical film is an anti-glare plate.

19. The illuminating device of claim 17, wherein the heat-dissipating substrate has a plurality of heat-dissipating surface that are side and bottom surfaces thereof.

20. The illuminating device of claim 17 further comprising a second separator inserted inside the accommodating tank roughly in parallel to the first separator to separate the first accommodating space, the second accommodating space, and a third accommodating space in the accommodating tank, wherein the second accommodating space is between the first accommodating space and the third accommodating space.

21. The illuminating device of claim 20 further comprising a cover board disposed between the transparent board and the third accommodating space and fixed in the third accommodating space.

22. The illuminating device of claim 17, wherein each of the protection covers has a vertical extension part with at least one positioning groove.
